(19) United States
(12) Patent Application Publication
(10) Pub. No.: US 2009/0241998 A1
(43) Pub. Date: Oct. 1, 2009

(54) Apparatus for foam-assisted wafer cleaning with use of universal fluid supply unit

(75) Inventors: Boris Kesil, San Jose, CA (US); Leonid Velikov, San Carlos, CA (US)

Correspondence Address: Boris Kesil;Multimetrixs, LLC, #200, 1040 Di Giulio Ave, Santa Clara, CA, 95050, US

(73) Assignee: MultimetRIXS, LLC

(21) Appl. No.: 12/079,169

(22) Filed: Mar. 26, 2008

(51) Int. Cl. B08B 3/10; B08B 13/00

(52) U.S. Cl. 134/99.2; 134/99.1; 134/102.1; 134/104.2; 134/102.3

(57) ABSTRACT

An apparatus for foam-assisted cleaning comprising a closable container with a funnel-shaped working chamber formed between the surface of the semiconductor wafer and the tapered base plate. The apparatus is provided with a fluid supply unit that incorporates a foam generator in the form of conical body with a flat surface on a wider end face of the conical body. This flat surface functions as a deflector for jets of neutral gas ejected onto the deflector and reflected therefrom into the interior of the fluid supply body filled with a foamable liquid. The jets of neutral gas create a zone of reduced pressure that generates gas bubbles which form the foam. The latter is displaced from the foam generator into the working chamber through a Bernoulli nozzle formed by the tip of the conical body and the outlet opening of the foam generator. The foam is formed from de-ionized water, isopropyl alcohol, and, if necessary, a surfactant. In a modified form, the apparatus is provided with a drying unit for generating an IPA/N² mist for eliminating spots left on the cleaned surface after evaporation of the residual drops of the cleaning liquid.

### FIELD OF THE INVENTION

The present invention relates to cleaning flat objects and, more specifically, to cleaning semiconductor wafers during production of electronic devices. In particular, the invention relates to a novel apparatus for semiconductor wafer cleaning and drying by using a universal fluid supply unit capable of selectively supplying to the wafer a foam-cleaning liquid, neutral gas, or a mist of alcohol with neutral gas for preventing formation of spots that may remain on the wafer surface after drying of residual drops of the cleaning liquid.

### BACKGROUND OF THE INVENTION AND DESCRIPTION OF PRIOR ART

Stringent surface-contamination-control requirements outlined in the International Technology Roadmap for Semiconductors (ITRS) pose new challenges in the technology of wafer-surface preparation. To meet ITRS requirements for surface preparation and to overcome the posed challenges, new processes and technology are required.

Modern semiconductor chips are complex three-dimensional structures of transistors and other electrical components. Particles in deionized water (DIW) and other process fluids can create defects by clinging to wafers, thus interfering with photolithography, as well as physical and chemical vapor-deposition processes. The purity of DIW is particularly important because DIW is used as the final rinse in most fabrication processes before proceeding to the next process. The prevailing opinion in the semiconductor industry is that the maximum allowable diameter of particulate contaminants in DIW equals one-half the line width of a semiconductor.

Currently there are several processes, as well as cleaning tools, that employ various physical principles of particle removal. These processes, which are listed below, differ according to the drag forces that remove contaminant particles from the object being cleaned.

Process 1: Particle-removal force is a viscous friction force in the flow of cleaning liquid. This takes place in a substantially laminar flow of liquids, and process efficiency is limited by the thickness of the boundary layer between the moving flow of liquid and the surface of the wafer to be cleaned.

Process 2: Particle-removal force is a random force that occurs as a result of a tangential breakdown in the turbulent flow of cleaning liquid. This case is observed in a substantially turbulent flow of liquid when the velocity of liquid flow is higher than the velocity of laminar flow. In reality, process efficiency is limited because of the difficulty in reaching a higher velocity of flow and because of cavitation, which causes deterioration of the surface being cleaned.

Process 3: Particle-removal force is a force occurring as a result of a tangential breakdown caused by turbulence in the flow of cleaning liquid. Turbulence in the cleaning liquid can be induced by exciting acoustic waves therein. This condition occurs in the majority of ultrasonic cleaning tools. Process efficiency is limited because of cavitation, which causes deterioration of the surface being cleaned.

Process 4: Particle-removal force is a friction force in the flow of a cleaning medium. Such force occurs in a substantially laminar flow of gases (e.g., CO₂) in the supercritical phase. A cleaning substance in the supercritical phase has kinematical viscosity, which is three orders less than in the ordinary condition. As a consequence, the boundary layer between the moving flow and the surface of the wafer being cleaned is approximately 10 times thinner than under ordinary conditions (mentioned in aforementioned Processes 1 and 2 above). The cost is high, and efficiency is limited because of equipment complexity and process.

Process 5: Particle-removal force is a surface-tension force that acts between the cleaning liquid and the particle to be removed. Cleaning processes of this type can be realized in several modifications, i.e., (a) in the well-known Marangoni process, which takes advantage of the surface tension gradient at the boundary between the wafer and the cleaning liquid; and (b) processes wherein the level of cleaning liquid into which the wafer is immersed is combined with ultrasonic waves induced in the liquid. Process efficiency is limited because of cavitation, which causes deterioration of the surface being cleaned and a slow cleaning rate.

Process 6: Particle-removal force is a surface-tension force that occurs between the meniscus of the cleaning medium and the particle to be removed. The cleaning process of this type uses foam cleaning liquids, the process being based on the fact that meniscus surface tension on the phase boundary, i.e., on the boundary between the surface to be cleaned and the cleaning-liquid meniscus, has a gradient. The main disadvantage of this foam-cleaning process is slow cleaning rate.

A modification of the aforementioned processes is a process in which the meniscus is created in a narrow gap between the surface to be cleaned and a special cleaning head that supplies cleaning liquid to the surface of the object and creates conditions for maintaining the meniscus. When the cleaning head is moved along the surface to be cleaned, contaminant particles move together with the head under the effect of surface tension and are removed.

The present invention concerns a novel universal apparatus that relates to the last-mentioned foam-assisted cleaning method.

Semiconductor devices, especially dense integrated circuits, are vulnerable to all contamination sources. Sensitivity is due to small-feature sizes and thinness of the deposited layers on the wafer surface. These dimensions are in the submicron range. The small physical dimensions of the devices make them very vulnerable to particulate contamination, which can be caused by workers, equipment, or processing chemicals. As the feature size and films become smaller, the allowable particle size must be controlled to smaller dimensions. In general, particle size should be 10 times smaller than the minimum feature size. Currently, the minimum feature size for commonly available semiconductor chips is 0.25 μm, therefore suggesting particle control to 0.025 μm.

Conventional cleaning technologies using condensed-phase solutions when properly applied can remove a majority of the contaminants generated during chemical processing of semiconductor wafers. Liquid systems currently in use can deliver satisfactory results, and an acceptable product can be produced. However, the current trend is to require the suppliers of chemicals and equipment to provide increasingly clean products. These suppliers are facing tremendous challenges as the feature size decreases. At the same time, semiconductor manufacturers do not want their costs to increase.

Another problem addressed by this invention is the drying of surfaces in the production of semiconductor wafers and similar devices.

Semiconductor wafers are not manufactured in a continuous process. Since there are many semiconductor wafer configurations, batches of wafers are processed through certain steps and are then stored. Later the batches are subjected to additional processing steps and are again stored. The processing and storage sequence may be repeated several times before processing is completed.

In general, at the end of each process sequence, the semiconductor wafers are dried, often immediately with start of the next step. Wafers can be transported from one process sequence to the next only after they have been dried, and they can be stored safely only when they are dry. The drying process is carried out frequently in the processing of a given wafer and therefore is very important.

Recently, isopropyl alcohol has become the preferred drying solvent. Various processes have been developed and commercialized using either hot or cold isopropyl alcohol and as a vapor, a liquid, or a combination of vapor and liquid. Producers of semiconductor wafers have been using less isopropyl alcohol because of its cost, fire hazards, disposal problems, and VOC (volatile organic compound) emissions.

Methods and apparatuses based on foam application have the following advantages:
single chamber for both cleaning and drying processes;
no metal parts in chamber, no contaminants introduced by processes;
no moving parts in chamber during process of cleaning and drying;
use of different chemical components for foam-creating liquids;
adjustment and control of foam over a wide range (including velocity of foam movement along wafer surface); and
prospective particle removal beyond 45 nm.

For example, U.S. Pat. No. 6,296,715 issued in 2001 to P. Kittle discloses surface cleaning and chemical treatment and drying of semiconductor substrates based on using foam as a medium instead of a condensed-phase liquid medium.

By introducing foam into an overflow vessel during cleaning and chemical treatment, the foam is caused to pass over the substrate in moving contact therewith. Drying of the substrate is carried out using a water solution of carbon dioxide in a pressurizable vessel. By releasing the pressure in the vessel, a layer of foam is established on the surface of the solution. The solution is discharged from the vessel, causing the foam layer to pass over the substrate in moving contact therewith. Carbon dioxide reduces surface tension of water, thereby enabling the foam layer to be produced and also assisting in the elimination of water from the surface of the substrate. In both cases, the use of foam reduces materials requirements and also reduces the quantity of particles deposited onto the substrate in the treatment process.

U.S. Patent Application Publication No. 20070135321 published in 2007 (inventor Bakul P. Patel, et al) relates to methods and compositions for treating a substrate surface using the foam from at least one treatment chemical. The invention more particularly relates to the removal of undesired matter from the surface of substrates with small features, where such undesired matter may comprise organic and inorganic compounds such as particles, films from photoresist material, and traces of any other impurities such as metals deposited during planarization or etching. The method according to the aforementioned invention for treating a substrate surface comprises generating a foam from a liquid composition, wherein the liquid composition comprises a gas, a surfactant, and at least one component selected from the group consisting of a fluoride, a hydroxylamine, an amine and periodic acid; contacting the foam with the surface of a substrate; and removing the undesired matter from the surface of the substrate.

The applicant has developed a novel foam-assisted method and an apparatus for cleaning semiconductor wafers, which are described in pending U.S. patent application Ser. No. ______. More specifically, the aforementioned application describes the main conception and organization of flow of fluids through the cleaning system, which is based on forming a funnel-shaped space between the base plate of the apparatus and the wafer to be cleaned and supplying a foam cleaning liquid to the aforementioned space through the central opening of the base plate for displacing the cleaning-liquid foam consisting of a plurality of bubbles from the center of the wafer toward the wafer periphery with a constant speed of movement of the bubbles provided by gradually decreasing the distance from the base plate to the wafer in the radial outward direction from the center of the wafer. The nanoparticles of contaminants are caught with a surface-tension force developed by bubble meniscuses on the wafer surface. The cleaning medium comprises de-ionized water foamed with the use of isopropyl alcohol and nitrogen. The apparatus also provides drying in the same chamber as that used for cleaning and improves efficiency and quality of drying by supplying to the aforementioned funnel-shaped space a mist formed from a mixture of isopropyl alcohol with nitrogen. Supply of such a mist to the cleaned surface prevents formation of spots that may remain on the cleaned surface after evaporation of residual drops of the foam cleaning liquid. A fluid supply unit distributes and supplies the aforementioned fluids, i.e., de-ionized water, isopropyl alcohol, and nitrogen, to the funnel-shaped space and switches the flow of fluids between various channels for realization of different modes of the apparatus operation.

Although the aforementioned pending U.S. patent application Ser. No. ______ describes the main conception of the foam-assisted cleaning process based on use of a funnel-shaped cleaning/drying chamber with positive supply of the foamed cleaning medium along the surface of the wafer, this application does not teach the structure and principle of operation of the fluid supply unit. Furthermore, in the above-described apparatus, positive movement of the foamed liquid in the direction from the center of the wafer to the wafer periphery is provided only under the effect of a jet of foam emitted through the central outlet opening of the fluid supply unit, which in some cases may be inefficient.

### OBJECTS AND SUMMARY OF THE INVENTION

It is an object of the invention to provide a foam-assisted wafer-cleaning apparatus of the type described in the pending U.S. patent application to be equipped with a novel, efficient, and versatile fluid supply unit. It is another object to provide the aforementioned foam-assisted wafer cleaning apparatus with additional means for driving the foamed cleaning liquid in the direction from the central part of the wafer to its periphery. A further object of the invention is to provide the aforementioned foam-assisted wafer-cleaning apparatus, wherein the fluid supply unit allows selective supply of a foamed cleaning liquid for cleaning the wafer surface, a mist of de-ionized water and nitrogen for drying the residue of the cleaning liquid, and nitrogen to purge the working cleaning/drying chamber or to form foam and/or mist.

The apparatus comprises a closable shallow container with a funnel-like base plate that is tapered radially outward from the center of the container toward the periphery of the container so that in a central cross-sectional plane perpendicular to the bottom of the container, the aforementioned funnel forms an obtuse angle ranging from 100° to an angle close to 180°. The upper side, or cover, of the shallow container supports a wafer-gripping mechanism, e.g., in the form of three wafer-edge gripping fingers, that can be moved radially inward for gripping the wafer or radially outward for releasing the wafer. When the wafer to be cleaned is supported by the wafer-gripping mechanism, it forms together with the base plate a combined funnel-shaped cleaning and drying space through which the foamed liquid is guided in the radial outward direction along the surface of the wafer.

The base plate has an outer diameter smaller than the inner diameter of the sidewall, or walls, of the container in order to form a peripheral foam-collecting space. The foam-collecting space has a foam-discharge opening connected to a foam-suppressing unit.

The fluid-supply unit is the heart of the system and receives, distributes, and directs fluids to the aforementioned funnel-shaped cleaning and drying space of the apparatus. This unit contains a foam generator. The latter consists of a tapered body, which is arranged coaxially with the central axis of the wafer and converges toward the wafer. The base, or wide side, of the tapered body has a flat surface that forms a gas deflector and is spaced with a predetermined gap over a plurality of circumferentially arranged channels for the supply of pressurized neutral gas, e.g., nitrogen, toward the gas deflector. The tapered body is located in a space for the foamed cleaning liquid, which consists, e.g., of de-ionized water and isopropyl alcohol. The upper part of this space is also tapered in the same direction as the tapered body. The tip of the tapered body is located in the center of an outlet opening from the foamed liquid space and forms together with this opening an outlet nozzle for the foamed liquid. Foam-emitting properties of this nozzle can be adjusted by shifting the tapered body in the axial direction toward or away from the outlet opening. The foam generator is connected to a source of pressurized nitrogen and to a source of the aforementioned foamed liquid. The fluid-supply unit has several nitrogen-supply pipes. One pipe is connected to a gas distributing and emitting chamber located directly under the aforementioned foam-generating deflector on the wide side of the tapered body. This chamber contains the aforementioned plurality of circumferentially arranged channels for the supply of pressurized neutral gas into the gap under the deflector. Another gas supply pipe supplies nitrogen to a plurality of channels circumferentially arranged near the outer periphery of the fluid-supply unit body in the direction perpendicular to the surface of the wafer. Exits from these channels are located near the periphery of the wafer and open into the aforementioned foam-collecting space. When pressurized gas is emitted through these exits, the gas creates an additional dragging force for positive movement of the foamed cleaning liquid to the foam-collecting space.

The apparatus operates as follows. The cover is disconnected from the shallow container or pivotally turned for access to the wafer-gripping mechanism, and the wafer to be treated is inserted into the gripper and clamped by moving the gripping fingers radially inward. The cover—with the wafer in the gripped position—is repositioned onto the shallow container. The funnel-shaped cleaning and drying space is purged with a flow of nitrogen and is then filled with a foamable cleaning liquid composed of de-ionized water and isopropyl alcohol. Then pressurized nitrogen is supplied into the chamber located under the deflector and from there accelerated flows of pressurized nitrogen are emitted through the circumferentially arranged channels to the deflector. When the gas flows around the deflector through the gap between the deflector and the bottom surface of the liquid-containing chamber and is emitted into the cleaning liquid, this creates a zone of reduced pressure where gas bubbles are formed. These bubbles flow up with significant velocity to the aforementioned nozzle formed by the tip of the tapered body and the outlet opening of the foam generator. Under the effect of gas pressure, the foamed structure accumulated in the central area under the wafer begins to move toward the wafer periphery in a substantially laminar flow. This movement is assisted by the dragging force generated under the effect of the peripheral radial outward flows of nitrogen.

The foam consists of a plurality of the aforementioned gas bubbles that possess high wetting properties relative to the surface of the wafer. The composition of the foam components, i.e., DI water, IPA, and nitrogen, is selected so that the cleaning liquid that forms the bubbles does not possess 100% wettability relative to the wafer surface and forms a plurality of meniscuses on the wafer surface. Thus, under the effect of the aforementioned positive pressure, the meniscuses will slide on the wafer surface to the foam collector, and, in the course of their movement, will catch particles of contaminants that may have dimensions as small as 250 to 400 nm. A particle-catching force results from a surface-tension-force gradient in the meniscus area, i.e., in the area of contact of the bubble wall with the wafer surface. The funnel shape of the foam-guiding space provides uniformity in the speed of movement of the meniscuses along the wafer surface.

Upon completion of the foam-cleaning step of the process, generation and supply of foam is discontinued, and gaseous nitrogen is supplied to the funnel-shaped space for displacing foam residue from the treated surface to the foam collector.

If necessary, the apparatus can transfer to the drying process without removing the cleaned wafer from the wafer-gripping mechanism. The drying process of the invention is very efficient, especially if the cleaning process leaves “islands” of cleaning liquid on the wafer surface. More specifically, a mist composed of IPA and N₂ is injected from the IPA/N₂ mist generator via the fluid-supply unit to the aforementioned funnel-shaped space and precipitates on the wafer surface, and then the funnel-shaped space is purged with nitrogen supplied from the N₂ tank, if necessary, in a hot state. The sequence of drying-cycle operations can be repeated several times. The above procedure eliminates formation of spots that remain on the wafer surface after evaporation of cleaning-liquid drops.

Upon completion of the drying operation, the shallow container is opened by raising the cover, and, if necessary, the wafer can be removed from the gripping mechanism, turned over, gripped with the gripping mechanism, and treated for cleaning on the other side (if this is a doubled-sided wafer) in the same manner as described above. If this is a one-sided wafer, upon completion of the drying cycle, the wafer can be gripped by the end effector of a mechanical arm and then sent to subsequent treatment or storage, e.g., in a FOUP.

### BRIEF DESCRIPTION OF THE DRAWINGS

FIG. 1 is a general schematic view of the apparatus of the invention.

FIG. 2 is a sectional view of a fluid-supply unit used in the apparatus of FIG. 1.

FIG. 3 is a sectional view of a modification of the foam generator suitable for use with the apparatus of the invention.

FIG. 4 is sectional view of a modified apparatus of the invention suitable for both foam cleaning and mist-assisted drying.

FIG. 5 is a flowchart of operations performed by the apparatus of the invention when the apparatus operates in only the foam-assisted cleaning mode.

FIG. 6 is a flowchart of operations performed by the apparatus of the invention when the apparatus sequentially operates in both foam-cleaning and mist-drying modes.

### DETAILED DESCRIPTION OF THE INVENTION

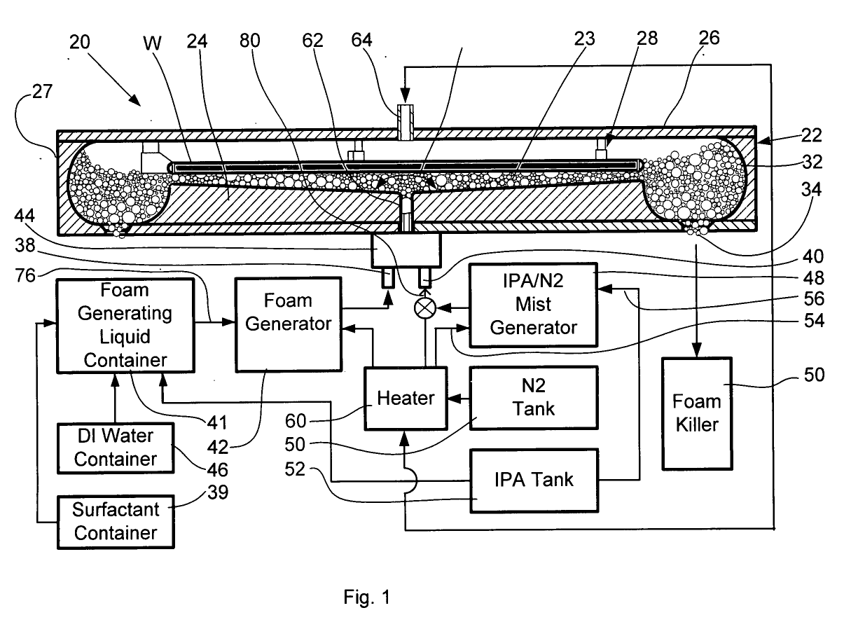

A general schematic view of the apparatus of the invention is shown in FIG. 1, which is a central cross-section of the apparatus. The apparatus is intended for cleaning/drying surfaces of semiconductor wafers with the use of a foam-cleaning-based technique. The apparatus, which as a whole is designated by reference numeral 20, contains a closable shallow container 22 with a funnel-shaped base plate 24, the upper surface of which is tapered radially outward from the center of the container 22 toward the periphery of the container so that in a central cross-sectional plane of the type shown in FIG. 1, perpendicular to the base plate 24 of the container 22, the aforementioned funnel shape forms an obtuse angle α ranging from 100° to an angle close to 180°. In other words, a funnel-shaped working chamber 23 is formed between the upper surface of the base plate 24 and the mating surface of the semiconductor wafer W. The distance from the base plate 24 to the facing surface of the wafer W gradually decreases from the center of the base plate 24 toward the periphery of the base plate 24. The obtuse angle α and the aforementioned distance are selected so as to provide a substantially constant speed of movement of the foam from the center of the base plate 24 to its periphery if pressurized gas is fed to the center of the base plate 24.

The upper side or cover 26 of the shallow container 22 supports a wafer-gripping mechanism 28, e.g., in the form of three wafer edge-gripping fingers that can be moved radially inward for gripping the wafer W or radially outward for releasing the wafer W. An example of such a mechanism is one disclosed in U.S. Patent Application Publication No. 2004/0102858 published May 27, 2004 (B. Kesil, et al). Thus, the interior 23 of the shallow closable container 22 is defined by the cover 26, sidewall 27 of the container 22, and the tapered surface 25 of the base plate 24.

The gripping mechanism 28 is properly attached to the inner surface of the cover 26 with drive units (not shown) located outside the shallow container. The cover 26 can be disconnected from the upper end face of the shallow closable container 22 or can be pivotally connected thereto by means of a hinge (not shown).

The base plate 24 has an outer diameter smaller than the inner diameter of the sidewall, or walls, of the container 22 in order to form a peripheral foam collector 32. The foam collector 32 has a foam-discharge opening 34 connected to a foam-suppressing unit 36. The foam-suppressing unit may be of any suitable type, e.g., one disclosed in U.S. Pat. No. 5,361,789 issued in 1994 to I. Yoshida, et al. After suppression of the foam, the used cleaning liquid can be discarded or filtered and recirculated.

The apparatus 20 is provided with a fluid-supply unit 44, which contains a foam generator 42 (described in more detail later), which, in turn, is connected to a source of de-ionized water 46 and an isopropyl-alcohol tank 52. If necessary, the container 41 for the foam-generating liquid may also be connected to a surfactant container 39. The fluid-supply unit 44 is also connected to a tank 50 that contains pressurized gaseous nitrogen. Nitrogen can be supplied to the fluid-supply unit 44 through a heater 60 and can be fed to this unit in a hot state.

A third fluid that can be delivered to the fluid-supply unit 44 is a mist of isopropyl alcohol and nitrogen. The mist is formed in a mist generator 48, the structure of which is described in more detail in aforementioned pending U.S. patent application Ser. No. ______ filed by the same applicant in 2008. The mist generator 48 is also connected to the pressurized-nitrogen tank 52. Thus, the mist composed of IPA and N₂ is injected from the IPA/N₂ mist generator 48 via the fluid-supply unit 44 to the aforementioned funnel-shaped space and precipitates on the wafer surface. The funnel-shaped working chamber 23 is then purged with nitrogen supplied from the N₂ tank 52, if necessary, in a hot state. The above procedure eliminates formation of spots remaining on the wafer surface after evaporation of cleaning-liquid drops.

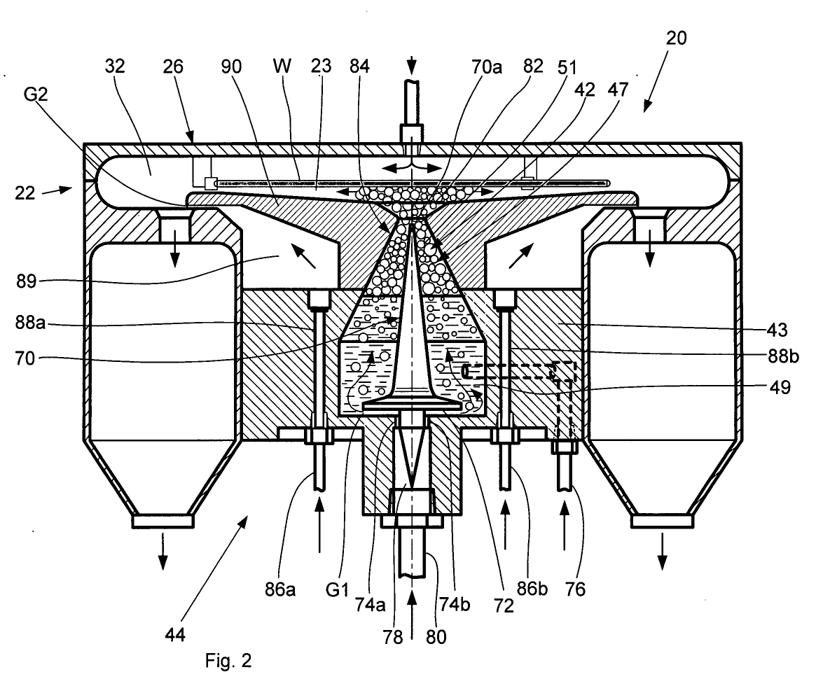

The fluid-supply unit 44, which is shown in more detail in FIG. 2 in a longitudinal sectional view, is the heart of the system. The fluid-supply unit 44 receives, distributes, and directs fluids to the aforementioned funnel-shaped cleaning and drying space 23 of the apparatus 20. This unit contains the aforementioned foam generator 42. The latter consists of a housing 43 having a foam-generating and directing chamber 47. The latter consists of a cylindrical foam-generating section 49 and an upwardly tapered foam-directing section 51. The foam-directing section 51 converges toward the wafer W. The foam-generating-and-directing chamber 47 contains a tapered body 70, which is arranged coaxially with the central axis of the wafer W and converges toward the wafer W. The base, or wide side, of the tapered body 70 has a flat surface 72 that forms a gas deflector and is spaced with a predetermined gap G1 over a plurality of circumferentially arranged channels (only two of which, i.e., 74a and 74b, are shown in FIG. 2). These channels are intended for ejecting pressurized neutral gas, e.g., nitrogen, against the flat surface of gas deflector 72.

The tapered body 70 is located in the middle of the aforementioned foam-generating-and-directing chamber 47 for a foamable cleaning liquid. As has been mentioned above, the foamable liquid consists, e.g., of de-ionized water and isopropyl alcohol. The foamable liquid is fed to the cylindrical foam-generating section 49 from the foam-generating liquid container 41 (FIG. 1) via a pipe 76. Reference numeral 78 designates a nitrogen-accumulation chamber. The latter is connected to a pressurized-nitrogen supply pipe 80 (FIGS. 1 and 2).

As has been mentioned above, the upper part of the foam-generating-and-directing chamber 47 comprises the foam-directing chamber 49 (FIG. 2), which is also tapered in the same direction as the tapered body 70. The tip 70a of the tapered body 70 is located in the center of an outlet opening 82 from the foam-directing section 51 and forms together with this opening an outlet nozzle 84 for the foamed liquid. Foam-emitting properties of this nozzle 84 can be adjusted by shifting the tapered body 70 in the axial direction toward or away from the outlet opening 82.

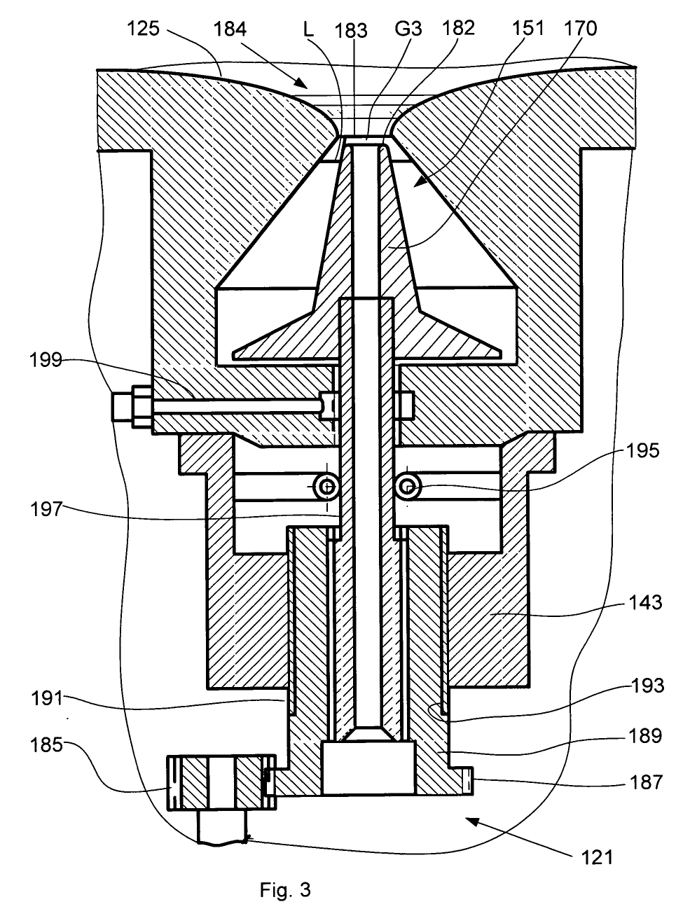

A sectional view of a modification of the foam generator 142 suitable for use with the apparatus of the invention is shown in FIG. 3. The foam generator 142 will be described later.

Referring to FIG. 2, it can be seen that through a collector (not shown), the pipe 80 (FIG. 2) and branched radial channels (only two of which, i.e., a channel 86a and a channel 86b, are shown in FIG. 2) may supply nitrogen also to a plurality of vertical channels, only two of which, i.e., a channel 88a and a channel 88b, are shown in FIG. 2. The channels 88a, 88b, etc., are arranged circumferentially and parallel to the central vertical axis of the tapered body 70 closer to the outer periphery of the fluid-supply unit housing 43 in the direction perpendicular to the surface of the wafer W. The channels 88a, 88b, etc., exit into a buffer space 89 that is used for generating positive pressure for the supply of nitrogen to a radial outward gap G2 formed between the lower end face of a downward-tapered nitrogen-guiding member 90 and the bottom 92 of the foam collector 32.

When pressurized gas is emitted through channels 88a, 88b, etc., to the foam collector 32, this creates an additional dragging force for positive movement of the foamed cleaning liquid from the center to the foam collector 32.

The apparatus 20 operates as follows. The cover 26 is disconnected from the shallow container 22 (for access to the wafer-gripping mechanism 28, which is shown in FIG. 1), and the wafer W to be treated is inserted into the gripping mechanism 28 and is clamped by moving the gripping fingers radially inward. The cover 26, with the wafer W in the gripped position, is repositioned onto the shallow container 22.

Pressurized nitrogen is supplied to the funnel-shaped cleaning and drying space 23 from the nitrogen tank 50 (FIG. 1), if necessary through the heater 60, and then through the pipe 80 (FIG. 2) via the nitrogen-accumulation chamber 78, nitrogen-ejecting channels 74a, 74b, etc., the foam-generating-and-directing chamber 47, and the outlet nozzle 84 for purging the cleaning and drying space 23. Following this, the foam-generating-and-directing chamber 47 is filled with foamable cleaning liquid composed of de-ionized water and isopropyl alcohol. The liquid is supplied from the foam-generating liquid container 41 through the pipe 76. Then pressurized nitrogen is fed via the pipe 80 to the nitrogen-accumulation chamber 78. From the chamber 78, via channels 74a, 74b, etc., accelerated flows of nitrogen are ejected onto the flat-surface deflector 72.

When gas flows around the deflector 72 through the gap G1 (FIG. 2) between the deflector 72 and the bottom surface of the cylindrical foam-generating section 49 and is emitted into the cleaning liquid that fills this section, this creates a zone of reduced pressure where gas bubbles are formed. These bubbles flow up with significant velocity to the aforementioned nozzle 84 formed by the tip 70a of the tapered body 70 (FIG. 2) and the outlet opening 82 of the foam generator 42. Under the effect of pressurized gas, the foamed structure accumulated under the wafer W in the central area of the funnel-shaped working chamber 23 (FIGS. 1 and 2) begins to move toward the wafer periphery in a substantially laminar flow. This movement is assisted by the dragging force generated under the effect of the peripheral and radial outward flows of nitrogen supplied to the peripheral area of the wafer via channels 88a, 88b, etc., and then via a radial outward gap G2.

The foam consists of a plurality of the aforementioned gas bubbles that possess high wetting properties relative to the surface of the wafer. The composition of the foam components, i.e., DI water, IPA, and nitrogen, is selected so that the cleaning liquid that forms the bubbles does not possess 100% wettability relative to the wafer surface and forms a plurality of meniscuses on the wafer surface. Thus, under the effect of the aforementioned positive pressure, the meniscuses will slide on the wafer surface to the foam collector 32, and, in the course of their movement, will catch particles of contaminants that may have dimensions as small as 250 to 400 nm. A particle-catching force results from a surface-tension-force gradient in the meniscus area, i.e., in the area of contact of the bubble wall with the wafer surface. The funnel shape of the foam-guiding space 23 provides uniformity in the speed of movement of the meniscuses along the wafer surface.

Upon completion of the foam-cleaning step of the process, generation and supply of foam discontinue, and gaseous nitrogen is supplied to the funnel-shaped space 23 for displacing foam residue from the treated surface to the foam collector 32.

If necessary, the apparatus 20 can transfer to the drying process without removing the cleaned wafer W from the wafer-gripping mechanism 28. The drying process of the invention is very efficient, especially if the cleaning process leaves “islands” of cleaning liquid on the wafer surface.

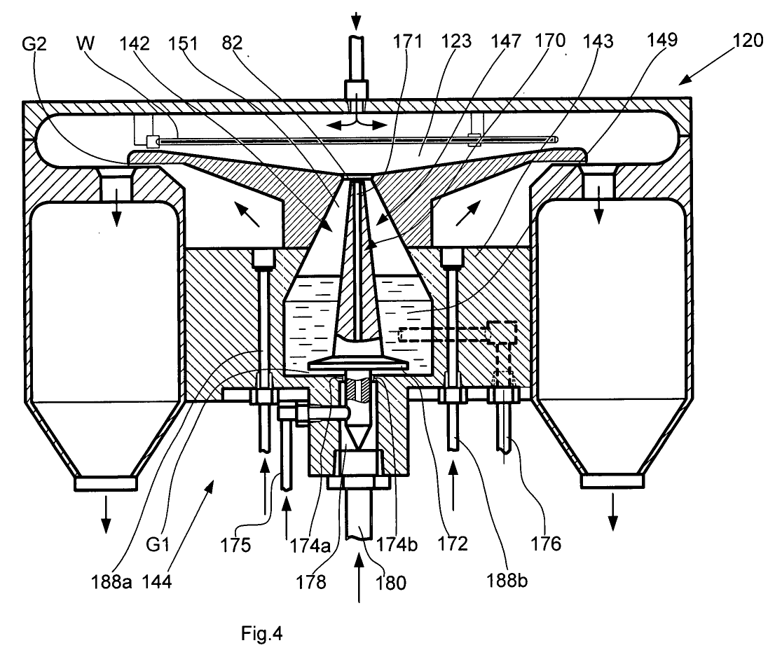

A modification of the apparatus 120 suitable for both foam cleaning and mist-assisted drying is shown in FIG. 4, which, in general, is the same as FIG. 2 except that the tapered body 170 has a central opening 171. Since all other parts and units of the apparatus 120, except for the mechanism 121 of axial displacement of the tapered body 170 shown in FIG. 3, are identical to parts and units of the apparatus shown in FIG. 2, they will be designated by the same reference numerals with the addition of the number “100.” For example, the tapered body 70 of FIG. 2 will be designated in FIG. 3 as 170, the housing 43 will be designated as 143, and the nozzle 84 will be designated as 184.

The aforementioned central opening 171 extends from the nitrogen-accumulation chamber 178 to the outlet opening 182 of the nozzle 184. In FIG. 4, reference numeral 175 designates a nitrogen-supply channel or the supply of nitrogen to the central opening 171 of the tapered body 170, and reference numeral 176 designates a channel for the supply of foamable fluid to the foam-generating section.

More specifically, a mist composed of IPA and N₂ is injected from the IPA/N₂ mist-generator 42 via the fluid-supply unit 44 to the aforementioned funnel-shaped space 23 and precipitates on the wafer surface. The funnel-shaped space 23 is then purged with nitrogen supplied from the N₂ tank 50 (FIG. 1), if necessary, in a hot state. The sequence of drying-cycle operations can be repeated several times. The above procedure eliminates formation of spots remaining on the wafer surface after evaporation of cleaning-liquid drops.

The modification of the apparatus 120 with the central opening 171 makes it possible to perform a foam-cleaning and mist-assisted drying operation in one working chamber 123. The central opening 171 together with the foam-directing section 151 forms a mist-forming diffuser that can efficiently operate at a predetermined level L (FIG. 3) of isopropyl alcohol in the foam-directing section 151 and at a predetermined amount of gap G3 between the end face of the tapered body 170 and the outlet opening 183 of the nozzle 184.

In order to adjust gap G3 to the optimal value, the tapered body has a mechanism 121 for axial displacement, as shown in FIG. 3. Although this mechanism can be accomplished in many different modifications, one shown in FIG. 3 comprises a gear wheel 185 engaged with a gear wheel 187 formed on the end of a sleeve 189 that has an outer thread 191 on its peripheral surface. This thread engages an inner thread 193 formed in the housing 143 so that when the gear wheel 185 rotates from a stepper motor, or the like (not shown), the sleeve 189, which is rigidly connected with the tapered body, moves in the axial direction and changes the value of gap G3. The gear wheel 185 is wider than the gear wheel 187 in order to maintain engagement when the gear wheel 187 shifts in the axial direction. A bearing 195 is used for supporting and guiding the stem 197 of the tapered body 170. Reference numeral 199 designates a nitrogen-supply channel for the supply of nitrogen to the foam-generating-and-directing chamber 147 for the foam-generating process. As shown in FIG. 3, the bottom surface 125 of the funnel-shaped chamber 123 may have a curvilinear profile.

During mist-assisted drying of the cleaning-liquid residue that may remain on the surface of the wafer W after cleaning, the foam-generating-and-directing chamber 147, which is now free from foam-generating liquid, is filled only with isopropyl alcohol, and pressurized nitrogen is fed to the channel 171 formed in the tapered body 170. In order to optimize mist-generating conditions at the tip of the nozzle 184 that in combination with the outlet opening 183 forms a Bernoulli nozzle, the gap G3 is adjusted by using the aforementioned mechanism of axial displacement, as shown in FIG. 3.

Upon completion of the drying operation, the working chamber 23 may be purged with nitrogen, the shallow container 22 is opened by raising the cover 26, and, if necessary, the wafer W is removed from the gripping mechanism 28, turned over, gripped with the gripping mechanism 28, and treated for cleaning on the other side (if this is a doubled-sided wafer) in the same manner as described above. If this is a one-sided wafer, upon completion of the drying cycle, the wafer W can be gripped by the end effector of a mechanical arm (not shown) and then sent to subsequent treatment or storage, e.g., in a FOUP.

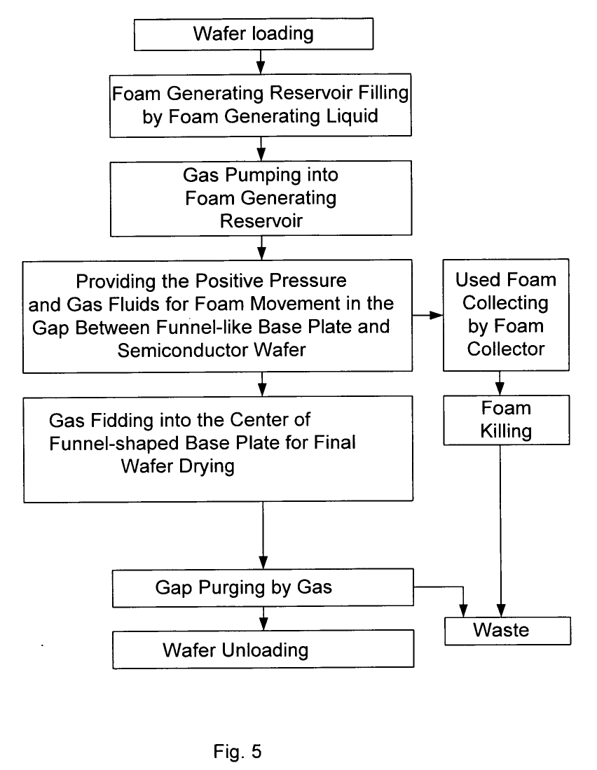

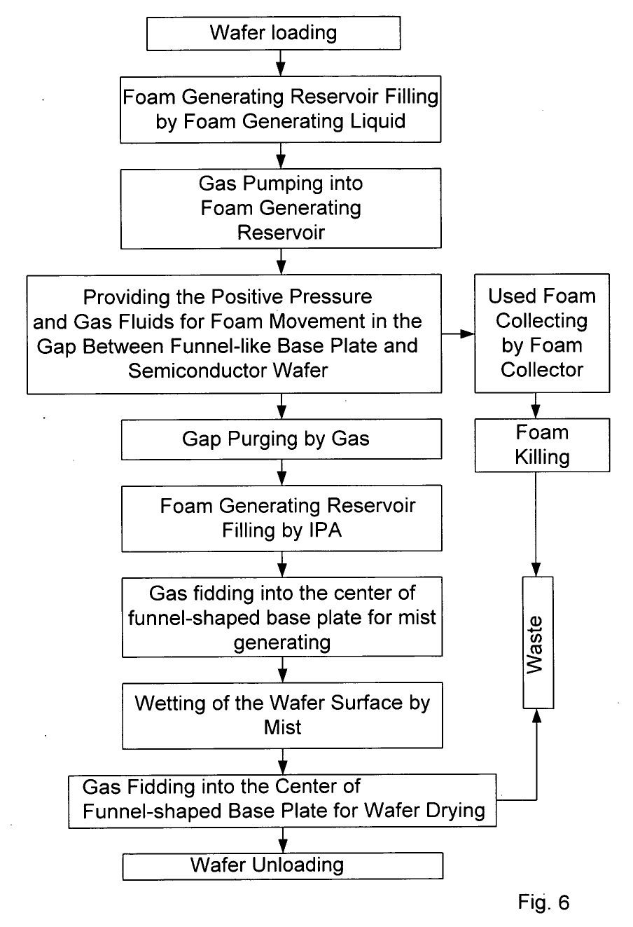

FIG. 5 shows a flowchart of operations performed by the apparatus 20 of the invention when the apparatus operates in only the foam-assisted cleaning mode, which has been described above. FIG. 6 shows a flowchart of operations performed by the apparatus of the invention when the apparatus sequentially operates in both foam-cleaning and mist-drying modes.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the cleaning liquid may have different components selected with reference to objects to be cleaned. The cleaning liquid may incorporate fluid other than isopropyl alcohols and surfactants of various types. The components can be mixed in different proportions. The foam collectors and foam-suppressing units are shown schematically since they may have any construction suitable for collecting and suppressing the foam, respectively. It is understood that the funnel shape is not a strict geometrical cone and that it may be a substantially funnel shape, e.g., with a slight increase in the taper angle toward the periphery. Moreover, the angle may vary in a wide range and even to negative values so that the working chamber may assume an umbrella-shape configuration with curvature in the direction opposite to the funnel shape. The curvature may have different radii.

1. An apparatus for foam-assisted wafer cleaning, comprising:
a closable container having an interior, a cover that can be opened or removed, and a funnel-shaped base plate that has a foam outlet opening, a periphery, and a tapered surface that tapers radially outward from aforementioned foam-outlet opening toward the aforementioned periphery, said funnel-shaped plate forming together with the semiconductor wafer a funnel-shaped working chamber;
a wafer-gripping mechanism for supporting the semiconductor wafer to be treated in a cleaning position, in which at least one funnel-shaped space is formed between the semiconductor wafer in said cleaning position, the center of the semiconductor wafer being coaxial with the center of the foam outlet opening in the base plate, and a distance from the base plate to the aforementioned surface of the wafer gradually decreasing from the foam-outlet opening toward the periphery;
a fluid supply unit connected to the aforementioned central opening;
a foam generator formed in the fluid supply unit and intended for converting cleaning liquid into foam;
a cleaning-liquid source that contains a foamable cleaning liquid and is connected to the foam generator; and
a source of pressurized neutral gas connected to the funnel-shaped working chamber through the foam generator, the aforementioned foam generator comprising a foam-generating-and-directing chamber that may be filled with a foamable cleaning liquid, a deflector located in said foam-generating-and-directing chamber capable of deflecting flows of pressurized neutral gas to the foamable cleaning liquid, and at least one gas-ejecting channel connected to said source of pressurized neutral gas for directing the flow of pressurized neutral gas onto the aforementioned deflector for creating in said foamable cleaning liquid a zone of reduced pressure where gas bubbles form and then produce foam.

2. The apparatus of claim 1, further comprising auxiliary neutral gas supply channels for the supply of pressurized neutral gas to the periphery of the semiconductor wafer for creating an auxiliary force for dragging the foamed cleaning liquid from the center of the semiconductor wafer to the periphery thereof.

3. The apparatus of claim 1, wherein the foam-generating-and-directing chamber has a foam-generating section with a flat bottom and a foam-directing section tapered toward the wafer; the aforementioned deflector being made in the form of a tapered body with a tip thereof at the converging end of the tapered body and a flat surface at the diverging end of the tapered body with a predetermined gap between the flat bottom of the foam-generating section and said flat surface of the deflector.

4. The apparatus of claim 2, wherein the foam-generating-and-directing chamber has a foam-generating section with a flat bottom and a foam-directing section tapered toward the wafer; the aforementioned deflector being made in the form of a tapered body with a tip thereof at the converging end of the tapered body and a flat surface at the diverging end of the tapered body with a predetermined gap between the flat bottom of the foam-generating section and said flat surface of the deflector.

5. The apparatus of claim 1, further comprising foam collectors formed in the closable container near the periphery of the semiconductor wafer.

6. The apparatus of claim 4, further comprising a foam collector formed in the closable container near the periphery of the semiconductor wafer.

7. The apparatus of claim 6, wherein the aforementioned auxiliary neutral gas-supply channels exit to the foam collector.

8. The apparatus of claim 3, further comprising gas-ejecting channels for ejecting said flow of pressurized neutral gas toward the flat surface of the deflector.

9. The apparatus of claim 3, further comprising a central opening formed in the tapered body that connects the source of pressurized neutral gas to the central opening of the funnel-shaped base plate.

10. The apparatus of claim 9, wherein the aforementioned central opening, the tip of the tapered body, and the foam-outlet opening altogether form a Bernoulli nozzle for generation of mist which is used to assist drying of the semiconductor wafer from residue of the foamable cleaning liquid.

11. The apparatus of claim 10, wherein the foamable cleaning liquid is supplied to the aforementioned nozzle from the cleaning-liquid source and comprises a mixture of de-ionized water with isopropyl alcohol, the mist being formed by said Bernoulli-type nozzle from the foamable cleaning liquid in combination with the aforementioned pressurized neutral gas.

12. The apparatus of claim 1, wherein the pressurized neutral gas is nitrogen.

13. The apparatus of claim 3, wherein the pressurized neutral gas is nitrogen.

14. The apparatus of claim 11, wherein the pressurized neutral gas is nitrogen.

15. The apparatus of claim 1, wherein the aforementioned tapered surface has a curvilinear profile.

16. The apparatus of claim 3, wherein the aforementioned tapered surface has a curvilinear profile.

17. The apparatus of claim 1, further comprising a mechanism of axial displacement of the tapered body.

18. The apparatus of claim 9, further comprising a mechanism of axial displacement of the tapered body.

19. The apparatus of claim 10, further comprising a mechanism of axial displacement of the tapered body.
